(19) United States
(12) Patent Application Publication
(10) Pub. No.: US 2018/0290346 A1
(43) Pub. Date: Oct. 11, 2018

(54) METHOD FOR PRODUCING AN ELASTOMER MEMBRANE AND ELASTOMER MEMBRANE

(71) Applicant: GEMUE GEBR. MUELLER APPARATEBAU GMBH & CO. KOMMANDITGESELLSCHAFT, INGELFINGEN (DE)

(72) Inventor: Gert Mueller, Kuenzelsau (DE)

(73) Assignee: GEMUE GEBR. MUELLER APPARATEBAU GMBH & CO. KOMMANDITGESELLSCHAFT, INGELFINGEN (DE)

(21) Appl. No.: 15/949,470

(22) Filed: Apr. 10, 2018

(30) Foreign Application Priority Data
Apr. 10, 2017 (EP) 17 305 428.9-1706

(51) Int. Cl. B29C 43/20; B29C 69/00

(52) U.S. Cl. CPC B29C 43/203; B29L 2031/755; B29K 2913/00; B29C 69/001

(57) ABSTRACT

A method for producing an elastomer membrane is proposed. The method includes the step of arranging an electronic data carrier between two layers in a predetermined position, wherein the electronic data carrier is connected at least temporarily to a positioning aid. Compression molding the two layers with the electronic data carrier arranged therebetween is also provided, wherein the positioning aid limits slippage of the electronic data carrier out of the predetermined position during the compression molding.

### CROSS-REFERENCE TO RELATED APPLICATIONS

This application relates and claims priority to European Application No. EP 17305428.9-1706 filed Apr. 10, 2017, the entire disclosure of which is incorporated herein by reference.

### BACKGROUND OF THE INVENTION

The invention relates to a method for producing an elastomer membrane and to an elastomer membrane.

When vulcanizing electronic data carriers in between coats or layers of an elastomer membrane, there is the problem that the electronic data carrier can slip towards the edge of the mold cavity during the vulcanizing process. As a result of this, the electronic data carrier may be damaged in the further production process or after the membrane has been dispatched for delivery.

DE 10 2013 214 84 A1 discloses a membrane provided with a membrane surface, which is a functional portion of the membrane. A tab is provided in which an electronic data carrier is arranged. The tab comprises an upper and a lower coat. The data carrier is enclosed by the layers of the tab and the upper and lower coat.

An object of the invention is therefore that of preventing a drifting movement of the electronic data carrier during vulcanization.

### SUMMARY OF THE INVENTION

The object underlying the invention is achieved by a particularized method.

The method comprises arranging an electronic data carrier between two layers in a predetermined position, the electronic data carrier being connected at least temporarily to a positioning aid. The method further comprises compression molding the two layers with the electronic data carrier arranged therebetween, the positioning aid limiting slippage of the electronic data carrier out of the predetermined position during the compression molding.

The proposed positioning aid results in the tolerances when arranging the electronic data carrier within the elastomer membrane being reduced. In other words, over a range of similar membranes, the electronic data carrier is positioned substantially at the same point within the membrane. Advantageously, waste during production can thus be minimized and the reading accuracy of the electronic data carrier is increased by ensuring the predetermined position.

Furthermore, by introducing the electronic data carrier in this early manufacturing step, the subsequent manufacturing steps can be parameterized. This is particularly advantageous since optical recognition of the membrane type is not possible on account of the usually dark or black optical characteristic of the membrane. The degree of automation of the manufacturing lines can therefore be increased. After the elastomer membrane has been dispatched for delivery, traceability of the elastomer membrane is ensured by the electronic data carrier.

In an advantageous embodiment, at least portions of the positioning aid remain in the elastomer membrane after the compression molding. As a result, the positioning of the electronic data carrier can advantageously be ensured until the end of the compression molding.

Another advantageous alternative embodiment is characterized in that the positioning aid is removed during the compression molding. In this way, advantageously no additional material remains in the elastomer membrane. For particular applications of the elastomer membrane, authorization for additional materials can thus be dispensed with.

One advantageous embodiment is characterized in that the positioning aid attaches the electronic data carrier to a compression molding die at least temporarily during the compression molding. The compression molding die advantageously helps the positioning aid to keep the electronic data carrier in the predetermined position.

One advantageous embodiment is characterized in that the method comprises: arranging the electronic data carrier between two first layers; compression molding the two first layers with the electronic data carrier arranged therein to form a pre-vulcanized positioning aid; arranging the pre-vulcanized positioning aid between the two second layers; compression molding the two second layers with the pre-vulcanized positioning aid arranged therein.

The pre-vulcanized positioning aid provides an enclosure for the electronic data carrier. Owing to said enclosure and the pre-vulcanization, an increased volume is provided around the data carrier during the actual vulcanization process, which advantageously leads to the drifting movement of the data carrier during vulcanization being limited.

One advantageous embodiment is characterized in that the method comprises: arranging the positioning aid, together with the electronic data carrier attached to the positioning aid, between the two layers; attaching the positioning aid relative to a compression molding die such that the electronic data carrier is in the predetermined position; compression molding the two layers with the positioning aid arranged therebetween to form a vulcanized material; and cutting off a flash of the vulcanized material and an excess length of the positioning aid.

By attaching the positioning aid to the compression molding die, it is possible to attach the data carrier with respect to the compression molding die and thus ensure that the predetermined position of the data carrier is not changed throughout the entire vulcanization process. As a result, the electronic data carrier can therefore be arranged in a very precise manner, resulting in degrees of freedom in the size of the associated tab, which may have a smaller size, for example.

One advantageous embodiment is characterized in that the positioning aid is a plastics overmold of the electronic data carrier and surrounds the electronic data carrier at least in portions. Advantageously, electronic data carriers formed in any manner and provided with a plastics overmold can thus be attached with respect to the compression molding die.

One advantageous embodiment is characterized in that the positioning aid is a substantially rigid printed circuit board material, in particular a phenoplast, in particular an epoxy resin, the electronic data carrier being arranged on the printed circuit board material. Advantageously, the pre-existing printed circuit board material is used to attach the electronic data carrier with respect to the compression molding die.

One advantageous embodiment is characterized in that the method comprises: attaching the electronic data carrier to a backing fabric; arranging the backing fabric and the electronic data carrier connected thereto between the two layers; compression molding the two layers with the backing fabric arranged therebetween. In this manner, the backing fabric, which may also be associated with additional functional portions such as the working region, may also advantageously be used to limit movement of the electronic data carrier during vulcanization.

One advantageous embodiment is characterized in that the electronic data carrier is glued onto the backing fabric in order to attach said data carrier.

One advantageous embodiment is characterized in that the method comprises: holding the electronic data carrier in the predetermined position relative to a mold cavity by means of the positioning aid formed as a holding means; arranging the layers around the held electronic data carrier; first compression molding of the two layers with the electronic data carrier held therebetween up to a first degree of vulcanization; removing the positioning aid from the electronic data carrier; and second compression molding of the two layers with the electronic data carrier located therebetween up to a second degree of vulcanization.

As a result, it is advantageously achieved that no additional foreign bodies remain in the elastomer membrane. By removing the positioning aid during the vulcanization process, it is advantageously achieved that a phase in which the electronic data carrier 4 threatens to drift out of position is skipped by securing the data carrier 4 during said vulcanization phase. The positioning aid is removed only after said vulcanization phase, and the data carrier 4 is thus protected from moving out of the predetermined position.

An advantageous development is characterized in that the positioning aid comprises two holding slides which are moved away from each other between the first and second compression molding steps. The electronic data carrier can thus be attached to the compression molding die in a simple manner.

One advantageous embodiment is characterized in that the electronic data carrier is arranged in a region of the elastomer membrane, in particular in a region of a tab protruding from a short side of the elastomer membrane that differs from a functional portion for providing a process fluid and from a clamping region for clamping the membrane.

### BRIEF DESCRIPTION OF THE DRAWINGS

Additional features and advantages of the invention are disclosed in the embodiments, which are subsequently described with reference to the figures of the drawings. Features are provided with the same reference signs even in different embodiments, without this being explicitly referred to again. In the drawings:

FIGS. 1, 4, 8, 12 and 15 each show a schematic flow chart;

FIG. 3 is a schematic perspective plan view of an elastomer membrane; and

FIGS. 2, 5, 6, 7, 9, 10, 11, 13, 14 and 16-19 are each a schematic cross section.

### DETAILED DESCRIPTION

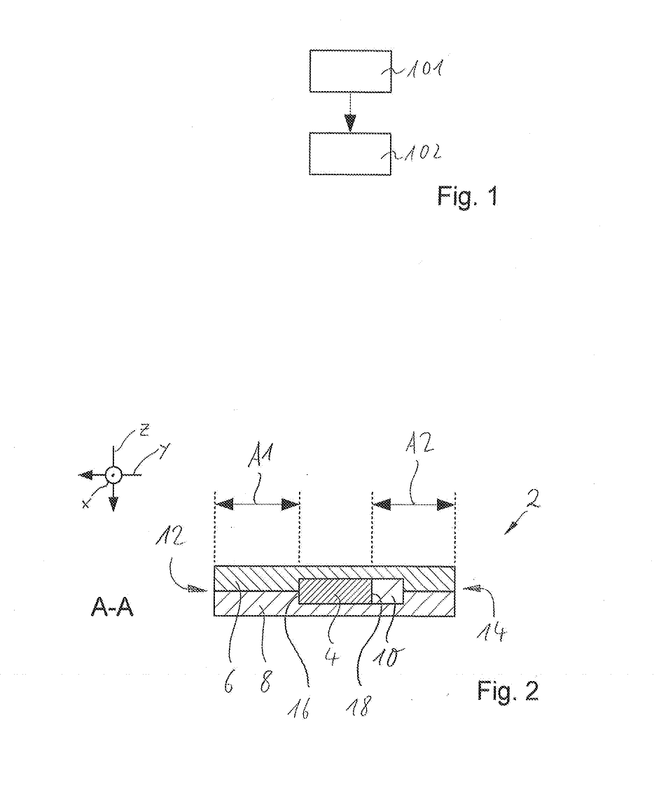

FIG. 1 shows a schematic flow chart of a method for producing an elastomer membrane. In a first step 101, an electronic data carrier is arranged at least temporarily between two layers in a predetermined position. The electronic data carrier is connected to a positioning aid. In a second step 102, the two layers are compression molded with the electronic data carrier arranged therebetween, the positioning aid limiting slippage of the electronic data carrier out of the predetermined position during the compression molding.

The two aforementioned layers are blank layers which are used as a starting material for vulcanizing and thus producing the elastomer membrane. The two layers are cut out of raw-rubber sheets following a pattern.

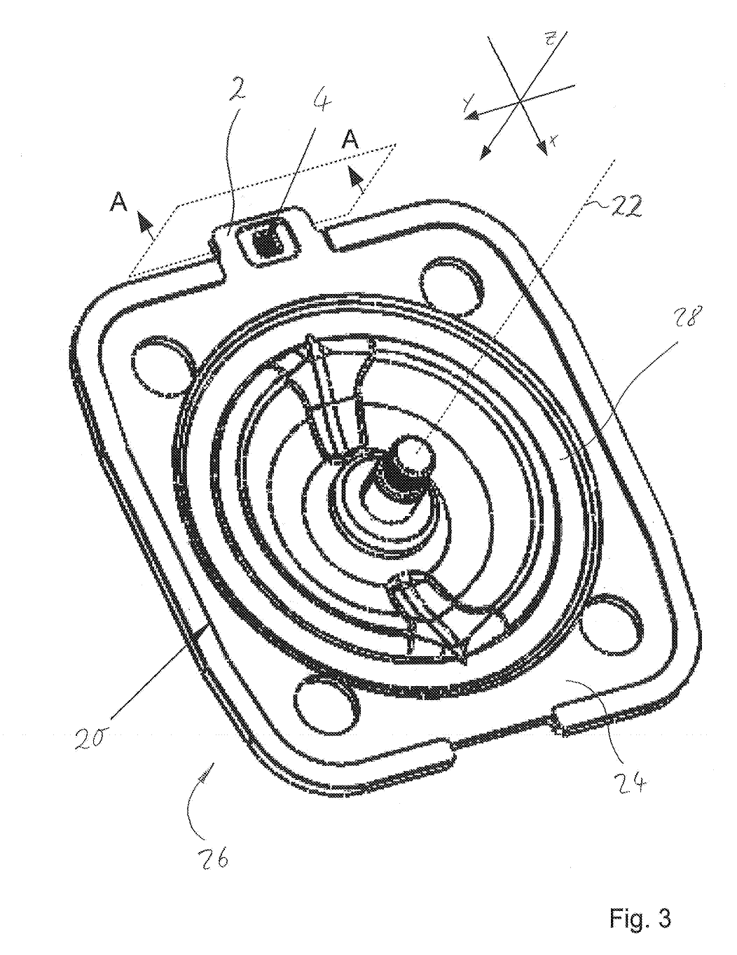

FIG. 2 shows a schematic cross section A-A from the following figure, FIG. 3. The cross section A-A shows a tab 2 of the elastomer membrane, in which the electronic data carrier 4 is arranged between two layers 6 and 8. After vulcanization has been carried out, the two layers 6 and 8 melt together and it is possible that they are no longer distinguishable from each other in the finished vulcanized elastomer membrane. The positioning aid 10 is fixed at least temporarily between the two layers 6 and 8 and mechanically connected to the data carrier 4, in order to limit the movement of the data carrier 4 out of the shown position.

The tab 2 is in particular a flat tab having two opposing short sides 12 and 14. The predetermined position of the data carrier 4 is characterized, for example, in that a distance A1 of a short side 16 of the data carrier 4 from the short side 12 of the tab 2 is substantially the same as a distance A2 of a short side 18 opposite the short side 16 from the short side 14 of the tab 2.

FIG. 3 is a perspective view of an elastomer membrane 20, which is substantially rotationally symmetrical about a feed axis 22. The body of the elastomer membrane 20 is manufactured substantially from an elastomer, but may of course contain additional materials. An elastomer is understood to be a molded material such as natural rubber or synthetic rubber which behaves in a soft-rubber-flexible manner when in a sufficient operating temperature range around ambient temperature. Small stresses cause considerable deformations; after the stress has been removed, said deformations spring back almost to the original dimensions. Synthetic rubbers are polymers which allow—after processing according to rubber technology methods—to be chemically loosely crosslinked and have wide temperature application ranges. The crosslinking reaction is known as vulcanization. In the present description, reference is made to a discontinuous compression molding method, in which the rubber blanks in the form of the at least two layers 6 and 8 are inserted into a recess or mold cavity and at this point the at least two mold halves allow for the vulcanization of the inserted rubber under pressure and elevated temperature.

The membrane 20 is arranged between a drive body and a valve body of the membrane valve. In a radially outer clamping portion 24, the membrane 20 is clamped between the drive body and the valve body in a fluid-tight manner. The membrane 20 is moved along the feed axis 22. When it is moved along the feed axis 22, the membrane 20 causes a fluid channel in the valve body to open and close. In this case, a medium side 26 of the membrane 20 is in contact with the provided process fluid. Alternatively, an additional membrane, for example a PTFE membrane, can be fastened to the medium side 26, the medium side 26 in this case not being in direct contact with the process fluid. The membrane 20 spans a membrane plane in parallel with an xy-plane. The membrane 20 comprises the tab 2 which projects into the membrane plane from a short side of the membrane 20. A working portion 28 of the membrane 20 provided for moving the membrane 20 is arranged radially inside the clamping portion 24. In contrast, the tab 2 is arranged radially outside the clamping portion 24.

Inside the tab 2 of the membrane 20, the electronic data carrier 4 is embedded between the two layers, FIG. 3 being shown open in the region of the data carrier 4 in the present case. The data carrier 4 is planar and in particular disc-shaped and the plane defined thereby lies substantially in the membrane plane or in a tab plane. The electronic data carrier 4 is in particular an RFID chip which comprises a transponder, by means of which data can be read out from the data carrier 4 using a reader arranged in the vicinity of the data carrier 4 and optionally also written into the data carrier 4.

Each of the layers mentioned in the present description can also be referred to as rubber cut-outs. A rubber cut-out of this kind is cut out and covers, for example in the form of layers 6 and 8, regions which are provided for producing the tab 2, the clamping region 24 and the functional portion 28. Of course, other variants for producing corresponding cut-outs are also conceivable.

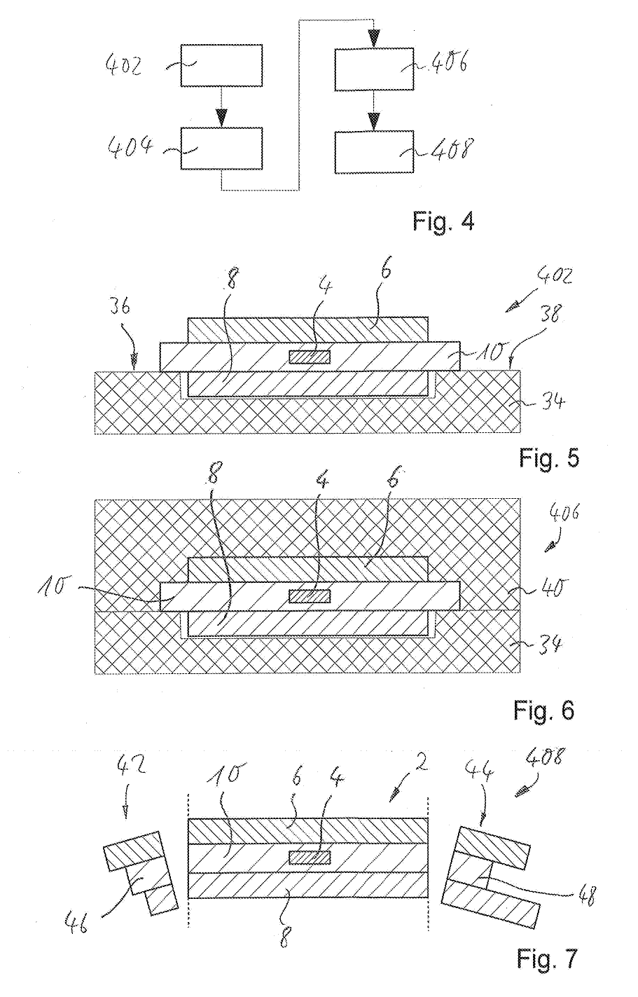

FIG. 4 shows a schematic flow chart. In one step 402, the positioning aid 10, together with the electronic data carrier 4 attached to the positioning aid 10, is arranged between the two layers 6 and 8. In one step 404, the positioning aid 10 is attached relative to a compression molding die such that the electronic data carrier 4 is in the predetermined position. In one step 406, the two layers 6 and 8 are compression molded with the positioning aid 10 arranged therebetween to form a vulcanized material. In one step 408, a flash of the vulcanized material and an excess length of the positioning aid are cut off and the tab 2 is formed.

FIG. 5 shows a cross section similar to the cross section A-A from FIG. 3 for illustrating step 402. The data carrier 4 is enclosed inside the positioning aid 10. The positioning aid is in the shape of a rod, for example. Of course, the data carrier 4 may also be surrounded by the positioning aid 10 only in part, or be supported thereby. In one step 402, the positioning aid 10 is arranged between the two layers 6 and 8. This structure is arranged in a first mold half 34, the positioning aid 10 resting on the first mold half 34 in holding portions 36 and 38.

FIG. 6 shows a cross section similar to the cross section A-A from FIG. 3 for illustrating step 406. A second mold half 40 comprises recesses in which the positioning aid 10 engages, meaning that the positioning aid is held securely in the mold cavity. After the positioning aid 10 has been attached relative to the compression molding die consisting of the first mold half 34 and the second mold half 40 according to step 404, the compression molding of the two layers 8 and 6 with the positioning aid 10 arranged therebetween takes place.

During this compression molding process according to step 406, the two mold halves 34 and 40 are moved towards each other and subjected to a pressure for a period of 3-10 minutes. At the same time, the mold halves 34 and 40 have a temperature of between 160° C. and 180° C., which is transferred to the vulcanized material. These details also apply to the other compression molding steps in the present description.

FIG. 7 shows a cross section similar to the cross section A-A from FIG. 3 for illustrating step 408. During the compression molding process, the material of the layers 8 and 6 starts to flow, combines (inter alia) together and assumes the form predetermined by the mold halves 34 and 40. In this case, the material also flows further outwards than is provided by the shape of the subsequent elastomer membrane 20. Said material that has flowed outwards is also referred to as flash. In step 408, the flash 42, 44 of the vulcanized material and the excess length 46, 48 are cut off and the tab 2 is formed. In the cross section shown in FIG. 7, the two layers 8 and 6 and the positioning aid 10 are cut off on either side in a flush manner, part, i.e. portions, of which positioning aid remain(s) in the elastomer membrane 20, in particular in the tab 2, in the present case.

In a first embodiment, the positioning aid 10 is a plastics overmold of the electronic data carrier 4. For this purpose, the electronic data carrier 4 is overmolded with a suitable heat-resistant plastics material in a step prior to step 402.

In an alternative embodiment, the electronic data carrier 4 is located on a printed circuit board, and thus the positioning aid 10 substantially comprises a rigid printed circuit board material. In this case, the electronic data carrier 4 is arranged on the printed circuit board material. Of course, the electronic data carrier 4 does not need to be entirely enclosed by the printed circuit board material here.

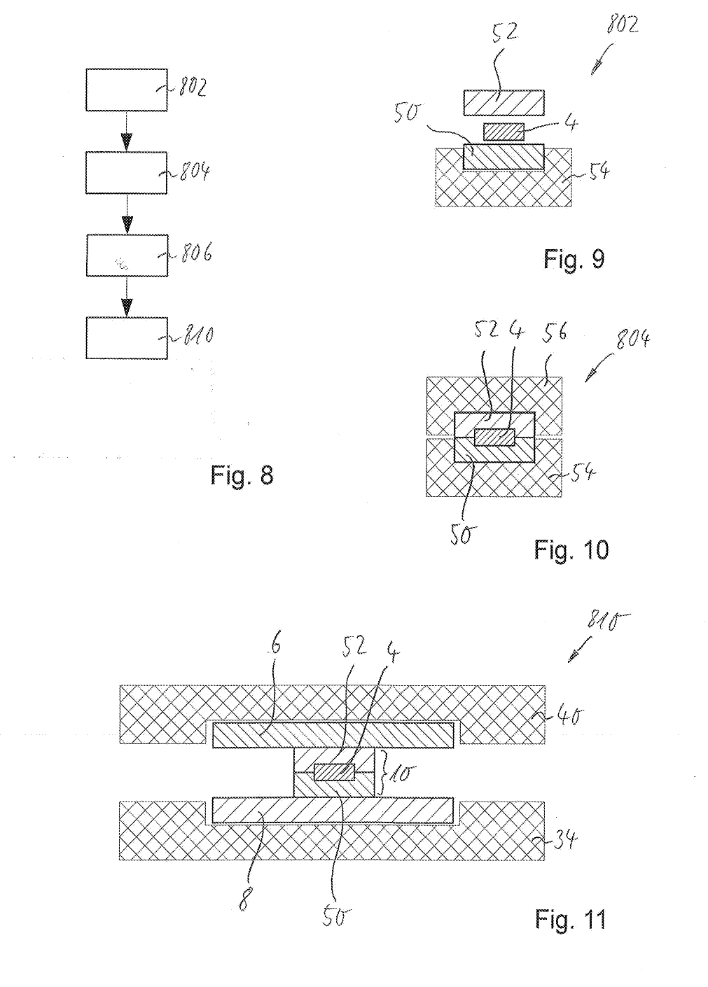

FIG. 8 shows a schematic flow chart. In one step 802, the electronic data carrier 4 is arranged between two first layers. In one step 804, a pre-vulcanized positioning aid is produced by compression molding the two first layers. In one step 806, the pre-vulcanized positioning aid is arranged between the two second layers in order to produce the elastomer membrane 20. In one step 810, the two second layers are compression molded with the pre-vulcanized positioning aid arranged therein.

FIG. 9 shows a cross section similar to the cross section A-A from FIG. 3 for illustrating step 802. The electronic data carrier 4 is arranged between the first layers 50 and 52, the two layers 50 and 52 comprising a starting material for the subsequent pre-vulcanization. This layer structure is then arranged in an additional first mold half 54.

FIG. 10 shows a cross section similar to the cross section A-A from FIG. 3 for illustrating step 804. An additional second mold half 56 encases the structure made of the two layers 50 and 52 and the data carrier 4 arranged between the two layers 50 and 52. By means of the mold halves 54 and 56, pre-vulcanization is carried out in order to encapsulate the data carrier 4 between the two layers 50 and 52. The capsule formed by the two layers 50 and 52 around the data carrier 4 forms the positioning aid 10.

FIG. 11 shows a cross section similar to the cross section A-A from FIG. 3 for illustrating step 810. In step 810, the positioning aid 10 in the form of a pre-vulcanized capsule is inserted between the layers 8 and 6, which are also referred to as second layers, and the final vulcanization for producing the elastomer membrane 20 takes place.

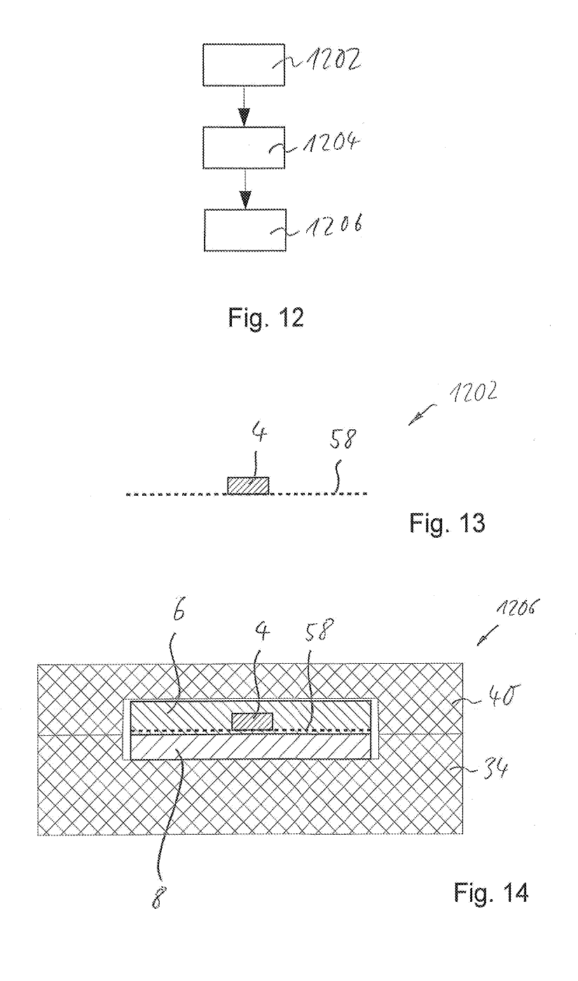

FIG. 12 shows a schematic flow chart. In one step 1202, the electronic data carrier 4 is attached to a backing fabric. In one step 1204, the backing fabric and the electronic data carrier 4 connected to the backing fabric are arranged between the two layers 6 and 8. In one step 1206, the two layers 6, 8 are compression molded with the backing fabric arranged therebetween and the data carrier 4 arranged thereon.

FIG. 13 shows, in one step, the arrangement of the data carrier 4 on the backing fabric 58, which extends from the tab 2 into the functional portion 28 of the elastomer membrane 20 to be produced. The backing fabric 58 has the primary function of preventing damage to or destruction of the functional portion 28. The additional function of the backing fabric 58 is that of limiting the movement of the electronic data carrier 4 during vulcanization. The data carrier 4 is preferably adhesively bonded to the backing fabric 58. However, other forms of attaching the data carrier 4 to the backing fabric 58 are of course also conceivable.

FIG. 14 shows a cross section similar to the cross section A-A from FIG. 3 for illustrating step 1206. The arrangement of the two layers 6 and 8 shown in FIG. 13 is arranged so as to be enclosed between the two mold halves 34 and 40 of the compression molding die. In one embodiment, the backing fabric 58 is not attached to one of the mold halves 34 and 40. In an alternative embodiment, the backing fabric 58 is held on at least one of the mold halves 34 and 40 during the compression molding process by a corresponding holding means.

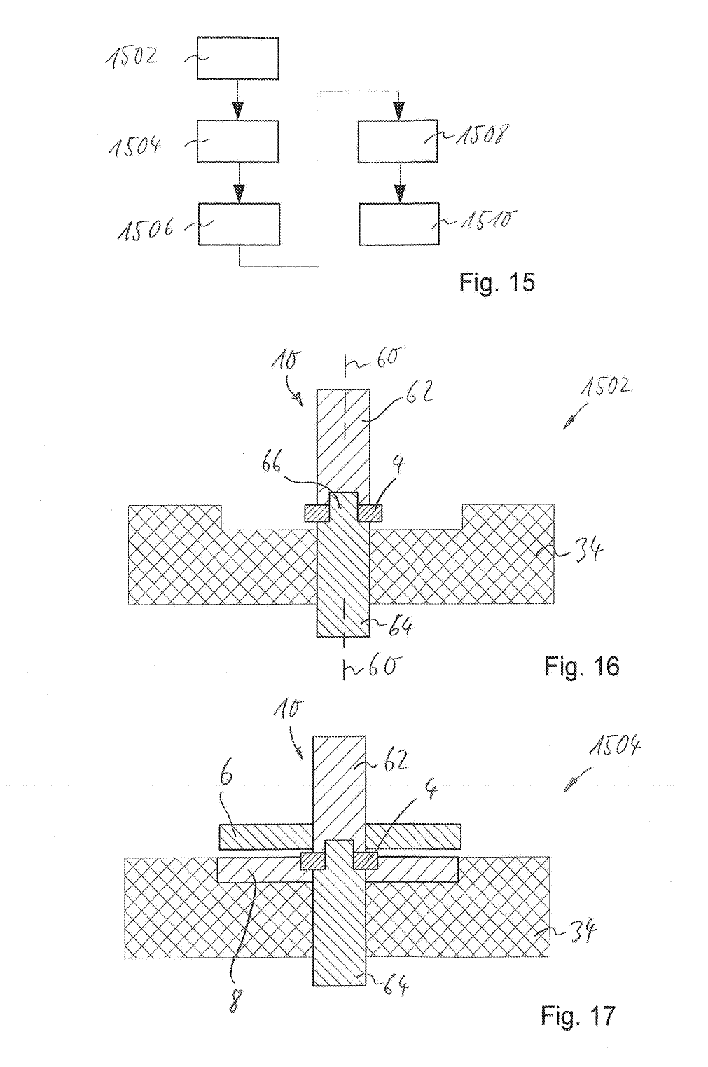

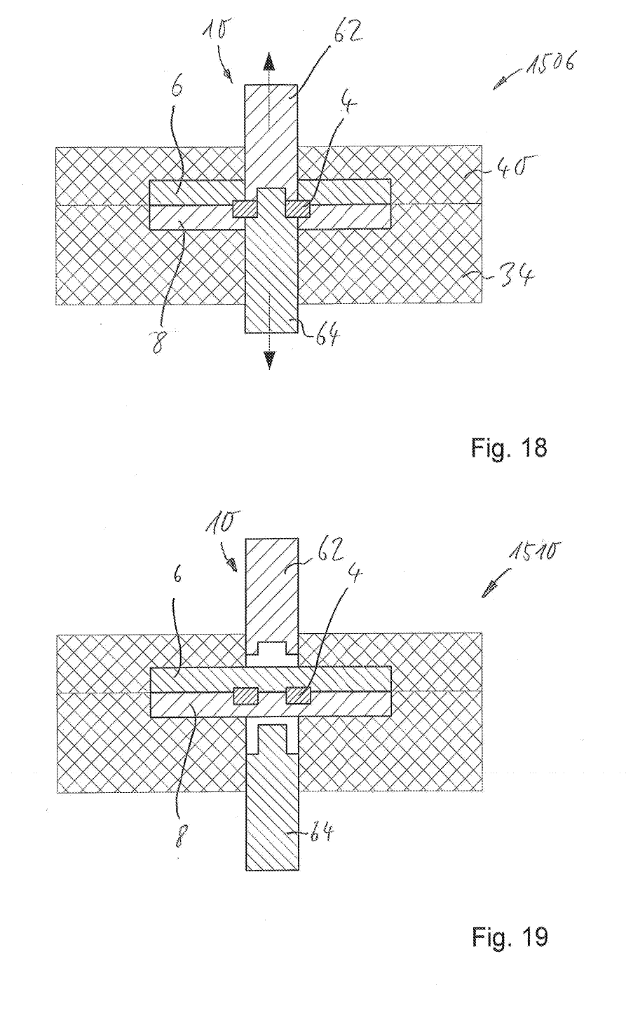

FIG. 15 shows a schematic flow chart. In one step 1502, the electronic data carrier 4 is held in a predetermined position relative to the mold cavity by means of the positioning aid formed as a holding means. In one step 1504, the layers 6 and 8 are arranged around the held electronic data carrier 4. In one step 1506, the two layers are compression molded with the electronic data carrier 4 held therebetween up to a first degree of vulcanization, in the sense of a pre-vulcanization. In one step 1508, the positioning aid 10 is removed from the electronic data carrier 4. In one step 1510, the two layers 6 and 8 are compression molded with the electronic data carrier 4 located therebetween up to a second degree of vulcanization, in the sense of a final vulcanization. The degree of vulcanization is understood, for example, to be a point in time during the vulcanization and compression molding. For example, the second degree of vulcanization is a point in time at 100% of the total period of vulcanization. The first degree of vulcanization is a point in time between 70-80% of the total period of vulcanization. In step 1508, the positioning aid 10 is thus removed after 70-80% of the total period of vulcanization.

FIG. 16 shows a cross section similar to the cross section A-A from FIG. 3 and serves to illustrate step 1502. In step 1502, the electronic data carrier 4 is held in the predetermined position relative to the mold half 34. For this purpose, the positioning aid 10 comprises two slides 62 and 64 which can move along a longitudinal axis 60. The electronic data carrier 4 comprises a through-opening in which a lug 66 of the slide 64 engages. The lug 66 protrudes out of the through-opening and is received by a corresponding recess in the slide 62. In addition, respective radially outer regions of the slides 62 and 64 engage in a particular surface of the electronic data carrier 4. The slides 62 and 64 thus attach the electronic data carrier 4 in the predetermined position in an interlocking manner. Of course, other embodiments of the positioning aid 10 are also conceivable in order to hold the electronic data carrier 4 in the predetermined position 4 in relation to the first mold half 34.

FIG. 17 shows a cross section similar to the cross section A-A from FIG. 3 and serves to illustrate step 1504. In step 1504, the electronic data carrier 4 is still held in the predetermined position relative to the first mold half 34 and the layers 8 and 6 are arranged around the electronic data carrier 4 and the positioning aid 10.

FIG. 18 shows a cross section similar to the cross section A-A from FIG. 3 and serves to illustrate step 1506. In step 1506, the first compression molding step is carried out up to the first degree of vulcanization. If the first degree of vulcanization is reached, the slides 62 and 64, as indicated by arrows pointing away from each other, are moved away from each other and from the data carrier 4 according to the subsequent step 1508.

FIG. 19 shows a cross section similar to the cross section A-A from FIG. 3 and serves to illustrate step 1510. In step 1510, the positioning aid 10 in the form of the slides 62 and 64 is removed from the electronic data carrier 4 and a second compression molding step is carried out up to the second degree of vulcanization. It is shown that the electronic data carrier 4, in comparison with FIG. 16, has not moved out of the predetermined position, and thus the slides 62 and 64 of the positioning aid 10 have limited the movement of the data carrier 4 out of the predetermined position.

The manufacturing steps introduced in the present description are carried out by means of a manufacturing device comprising a compression molding die. Correspondingly, the manufacturing device is designed to carry out the manufacturing steps.

What is claimed is:

1. A method for producing an elastomer membrane, the method comprising:
arranging an electronic data carrier between two layers in a predetermined position, wherein the electronic data carrier is connected at least temporarily to a positioning aid; and
compression molding the two layers with the electronic data carrier arranged therebetween, wherein the positioning aid limits slippage of the electronic data carrier out of the predetermined position during the compression molding.

2. The method according to claim 1, wherein at least portions of the positioning aid remain in the elastomer membrane after the compression molding.

3. The method according to claim 1, wherein the positioning aid is removed during the compression molding.

4. The method according to claim 1, wherein the positioning aid attaches the electronic data carrier to a compression molding die at least temporarily during the compression molding.

5. The method according to claim 2, wherein the method comprises:
arranging the electronic data carrier between two first layers;
compression molding the two first layers with the electronic data carrier arranged therein to form a pre-vulcanized positioning aid,
arranging the pre-vulcanized positioning aid between the two second layers;
compression molding the two second layers with the pre-vulcanized positioning aid arranged therein.

6. The method according to claim 2, wherein the method comprises:
arranging the positioning aid, together with the electronic data carrier attached to the positioning aid, between the two layers;
attaching the positioning aid relative to a compression molding die such that the electronic data carrier is in the predetermined position;
compression molding the two layers with the positioning aid arranged therebetween to form a vulcanized material; and
cutting off a flash of the vulcanized material and an excess length of the positioning aid.

7. The method according to claim 6, wherein the positioning aid is a plastics overmold of the electronic data carrier and surrounds the electronic data carrier at least in portions.

8. The method according to claim 6, wherein the positioning aid is a substantially rigid printed circuit board material, and wherein the electronic data carrier is arranged on the printed circuit board material.

9. The method according to claim 2, wherein the method comprises:
attaching the electronic data carrier to a backing fabric;
arranging the backing fabric and the electronic data carrier connected thereto between the two layers;
compression molding the two layers with the backing fabric arranged therebetween.

10. The method according to claim 9, wherein the electronic data carrier is glued onto the backing fabric in order to attach said data carrier.

11. The method according to claim 3, comprising:
holding the electronic data carrier in the predetermined position relative to a mold cavity by means of the positioning aid formed as a holding means;
arranging the two layers around the held electronic data carrier;
first compression molding of the two layers with the electronic data carrier held therebetween up to a first degree of vulcanization;
removing the positioning aid from the electronic data carrier; and
second compression molding of the two layers with the electronic data carrier located therebetween up to a second degree of vulcanization.

12. The method according to claim 11, wherein the positioning aid comprises two holding slides which are moved away from each other between the first and second compression molding steps.

13. The method according to claim 1, wherein the electronic data carrier is arranged in a region of the elastomer membrane, in particular in a region of a tab protruding from a short side of the elastomer membrane that differs from a functional portion for providing a process fluid and from a clamping portion for clamping the elastomer membrane.

14. A manufacturing device for producing an elastomer membrane, which device comprises:
means for arranging an electronic data carrier between two layers in a predetermined position, wherein the electronic data carrier is connected at least temporarily to a positioning aid; and
means for compression molding the two layers with the electronic data carrier arranged therebetween, wherein the positioning aid limits slippage of the electronic data carrier out of the predetermined position during the compression molding.

15. An elastomer membrane in which an electronic data carrier is arranged between two layers in a predetermined position, wherein the electronic data carrier is connected at least temporarily to a positioning aid during production; and wherein the two layers are compression molded with the electronic data carrier arranged therebetween, wherein the positioning aid limits slippage of the electronic data carrier out of the predetermined position during the compression molding.
